(19) United States
(12) Patent Application Publication
(10) Pub. No.: US 2025/0290896 A1
(43) Pub. Date: Sep. 18, 2025

(54) METHOD AND APPARATUS FOR IMPROVING FALSE ALARM RATE IN TRACE DETECTION

(71) Applicant: SMITHS DETECTION-WATFORD LIMITED, Hemel Hempstead (GB)

(72) Inventor: IMMACOLATA Procino, London (GB)

(21) Appl. No.: 18/860,880

(22) PCT Filed: Apr. 28, 2023
(86) PCT No.: PCT/GB2023/051148

§ 371 Date: Oct. 28, 2024

(30) Foreign Application Priority Data
Apr. 28, 2022 (GB) 2206226.9

(51) Int. Cl. G01N 27/622

(52) U.S. Cl. CPC G01N 27/622

(57) ABSTRACT

The disclosure provides a spectrometer for detecting a substance of interest, the spectrometer including: a chamber through which a number of sample ions travel from an ion gate to a collector electrode; a detector, connected to the collector electrode for detecting arrival of sample ions at the collector electrode; a controller configured to: control parameters of the spectrometer to selectively increase or decrease the number of sample ions which pass into the chamber upon each opening of the ion gate, detect arrival of the sample ions at the collector electrode to obtain detection signals during a set of time windows following opening of the ion gate, analyse the detection signals in the time windows according to the parameters of the spectrometer to detect the presence of the substance of interest.

### CROSS-REFERENCE TO RELATED APPLICATIONS

The present application is a national stage entry of PCT/GB2023/051148 filed on Apr. 28, 2023, which claims the benefits of GB Patent Application No. 2206226.9 filed on Apr. 28, 2022, the contents of which are hereby incorporated by reference in their entirety.

### BACKGROUND

The present disclosure relates to methods and apparatus, and in particular methods and apparatus for analysing substances by detecting ions, and still more particularly to methods which adapt the analysis applied to spectrometry signals according to the parameters of the spectrometer.

Ion mobility spectrometers (IMS) can identify material from a sample of interest by ionising the material (e.g., molecules, atoms, and so forth) and measuring the time it takes the resulting ions to travel a known distance through a counterflow of drift gas under a known electric field. Typically this time is measured from the time an ion gate (which may also be referred to as an ion shutter) is opened, to the time that ion arrives at a detector such as a Faraday cup.

Each ion's time of flight is associated with the ion's mobility. An ion's mobility relates to its mass and geometry. Therefore, by measuring the time of flight of an ion it is possible to infer its identity. These times of flight may be displayed graphically or numerically as a spectrum.

Some IMS cells include detectors which collect ions to measure their time of flight so they can be identified, this may be done in the presence of a drift gas so that mobility effects can separate the ions. Other types of detectors may use travel time through a chamber under electric field in the absence of drift gas to measure mass to charge ratio. Such devices may be referred to as time-of-flight mass spectrometers (TOF-MS).

These and other technologies are widely used for detection of chemicals. One of the fundamental characteristics of a detector is its sensitivity. Sensitivity is one way to indicate the minimum detectable concentration of a substance of interest. The sensitivity is strongly correlated to the False Alarm Rate (FAR) of the instrument and an increase in sensitivity often corresponds to an increase in FAR.

### BRIEF DESCRIPTION

The present disclosure aims to provide improved sensitivity and improved false alarm rate.

Embodiments of the disclosure are set out in the appended claims.

There is provided a spectrometer for identifying presence of a substance of interest, the spectrometer including:
a chamber through which a number of sample ions travel from an ion gate to a collector electrode;
a detector, connected to the collector electrode for detecting arrival of sample ions at the collector electrode;
a controller configured to:
   control parameters of the spectrometer to selectively increase or decrease the number of sample ions which pass into the chamber upon each opening of the ion gate,
   detect arrival of the sample ions at the collector electrode to obtain detection signals during a set of time windows following opening of the ion gate,
   analyse the detection signals in the time windows according to the parameters of the spectrometer to identify the presence of the substance of interest.

The parameters may include at least one of:
(i) gate width,
(ii) quantity of sample vapour introduced to a reaction region including an ioniser, and
(iii) a duration for which ions are kept in the reaction region before opening of the ion gate.

Although any one or more of these parameters may be used to increase or decrease the number of sample ions which pass into the chamber upon each opening of the ion gate it is believed that gate width may be the most effective in typical IMS systems.

Analysing the detection signals according to the parameters may include:
selecting at least one detection criterion based on the parameters, and
identifying the presence of the substance of interest based on the detection signals and the at least one detection criterion.

For example the detection criterion may include a detection threshold in a particular time window, or a signature associated with a substance of interest. Such signatures include an expected peak shape, and the controller may be configured to detect peak shape, this may be done based on any appropriate curve matching or fitting algorithm.

The signature may include a presence of a monomer peak and/or a dimer peak associated with the substance of interest. For example, a particular substance may be detected based only on its monomer peak or based only on its dimer peak, or based on the presence of the monomer peak at one gate width and the presence of the dimer peak at a different gate width.

The controller may be configured to select the time windows according to the parameters, and to deactivate some of the time windows when certain gate widths are used. For example time windows associated with known interferents may be deactivated.

The controller may be configured to:
operate the spectrometer with first parameters to obtain first detection signals and to apply first detection criteria to the first detection signals, and then to
operate the spectrometer with second parameters to obtain second detection signals and to apply second detection criteria to the second detection signals, wherein the second detection criteria are different from the first detection criteria.

The first detection criteria may include at least one of: (a) first detection thresholds for the time windows, (b) one or more expected peak shapes for the time windows; (c) the activation or deactivation of selected time window(s).

The disclosure also provides a method of controlling a spectrometer, the spectrometer including:
a chamber through which sample ions travel from an ion gate to a collector electrode wherein the spectrometer is configured to discriminate between ions based on their travel time to the collector electrode;
a detector, connected to the collector electrode for detecting arrival of sample ions at the collector electrode;
   the method including:
operating the spectrometer according to first parameters, and detecting arrival of the sample ions at the collector electrode to obtain first detection signals associated with the first parameters,
operating the spectrometer according to second parameters, and detecting arrival of the sample ions at the collector electrode to obtain second detection signals associated with the second parameters wherein the first parameters are different from the second parameters
wherein said detection signals include detection of the arrival of ions during a set of time windows following opening of the ion gate,
the method further including analysing the first detection signals according to first detection criteria, and analysing the second detection signals according to second detection criteria, wherein the first detection criteria are different from the second detection criteria.

As noted above the parameters generally include at least one of: (i) gate width, (ii) quantity of sample vapour introduced to a reaction region including an ioniser, and (iii) a duration for which ions are kept in the reaction region before opening of the ion gate.

Embodiments of the disclosure provide computer program products and controllers configured to control a spectrometer to perform any one or more of the methods described herein. Typically the control logic is connected to the detector and the ion gate of the spectrometer.

Embodiments vary gate width (the opening time of the ion gate) between operations of the detector, so that the detector can be operated with one gate width and then with another, different gate width. The variation in gate width provides a consequent variation in sensitivity of the instrument. A different detection algorithm may be used for each of the two gate widths. Other ways of adjusting sensitivity may also be used

Embodiments relate to dynamic adjustment of ion gate opening time (gate width) and of the detection algorithm used. These embodiments may be used in IMS.

Embodiments may have the advantage that a single detector could be employed to detect a very wide range of concentrations of different chemical hazards, without the need for the user to change the operational configuration.

Embodiments may also have the advantage that the adjustment of the detection algorithm allows increasing the dynamic range response of the detector against specified chemical hazards and/or providing increased sensitivity to chemical hazards whilst controlling or avoiding sensitivity to interferents.

An aspect of the disclosure provides a computer program product, such as a computer readable signal or tangible non-transitory computer readable storage medium including program instructions for programming a controller of an ion mobility spectrometry apparatus to perform any of the methods described or claimed herein.

Any feature of any one of the examples disclosed herein may be combined with any selected features of any of the other examples described herein. For example, features of methods may be implemented in suitably configured hardware, and the configuration of the specific hardware described herein may be employed in methods implemented using other hardware.

### BRIEF DESCRIPTION OF THE DRAWINGS

Embodiments of the disclosure will now be described in detail with reference to the accompanying drawings, in which:

FIG. 1 shows a cut away view of an ion mobility spectrometer;

FIG. 2 is a schematic diagram indicating detection windows such as those employed in the methods and apparatus described herein;

FIG. 3 is an illustration of two plots of detection signals such as those obtained using two particular gate widths in the presence of a first particular chemical;

FIG. 4 is an illustration of two plots of detection signals such as those obtained using two particular gate widths in the presence of a second particular chemical

FIG. 5 is a flowchart illustrating a mode of operation of a spectrometer such as that illustrated in FIG. 1; and

FIG. 6 is a flowchart illustrating a mode of operation of a spectrometer such as that illustrated in FIG. 1.

In the drawings like reference numerals are used to indicate like elements.

### DETAILED DESCRIPTION

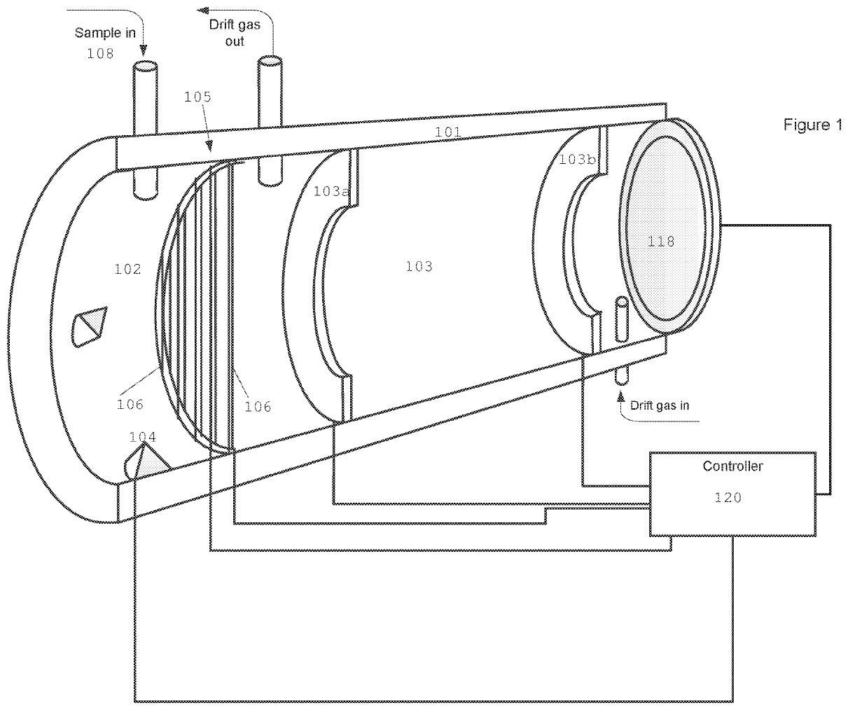

The ion mobility spectrometer of FIG. 1 includes a reaction region 102, an ionisation source 104 for ionising gaseous fluid in the reaction region 102, an ion shutter 105, a collector electrode 118 such as a Faraday cup, and a controller 120.

The controller 120 is connected to the ion shutter 105 and to the collector electrode for sensing arrival of ions at the collector electrode. The controller may also be connected for operating the ionisation source 104. In typical operation, each time a sample of gaseous fluid (such as vapour) is provided into the reaction region, the controller 120 provides a pulse or series of pulses of the ionisation source 104. Following each pulse the controller 120 opens the ion shutter 105 after a “gate delay”, the length of time for which the shutter 105 is held open is referred to as the “gate width” or gate opening time as distinct from the gate delay.

During the gate width, ions generated in the reaction region 102 travel out of the reaction region 102 along the drift region 103 of the spectrometer to the collector electrode. The number of ions which pass the gate into the drift region depends on the gate width. Longer gate width means more ions, and as a result a higher ion current at the collector electrode. Conversely shorter gate width means fewer ions and lower ion current. The sample ions are then detected at the collector electrode to obtain detection signals during a set of time windows following opening of the ion gate.

The spectrometer includes a housing, such as a tube 101. The reaction region 102 is at one end inside this housing 101, and separated from the collector electrode 118 by a drift region 103. The reaction region 102 is separated from the drift region 103 by the ion shutter 105. The housing 101 includes an inlet 108 for enabling a sample of gaseous fluid (such as vapour, and/or gas, and/or an aerosol) to be introduced into the reaction region 102.

The ion shutter 105 includes two electrodes 106, 107, which are coupled to the controller 120 to enable a barrier voltage to be provided between the two electrodes 106, 107. When the shutter 105 is “closed” this barrier voltage acts to prevent ions from travelling from the reaction region into a drift region of the IMS, and an open state in which ions can travel into the drift region towards the detector. The ion shutter 105 may include a Tyndall-Powell, Bradbury-Nielsen shutter, or other type of shutter. The shutter electrodes 106, 107 may each include elongate conductors, and the elongate conductors of the first shutter electrode 106 may be aligned in the drift direction with the elongate conductors of the second shutter electrode 107. The elongate conductors of each shutter electrode 106, 107 may be arranged as a grid, such as a mesh, for example a triangular, rectangular, hexagonal, or other regular or irregular mesh. The shutter electrodes 106, 107 need not be separated in the drift direction. For example they may be coplanar, in which case the elongate conductors may be interdigitated, for example they may be interleaved or interwoven.

The ionisation source 104 is arranged for ionising the sample in the reaction region. In the example illustrated in FIG. 1, the ionisation source 104 includes a corona point. The ionisation source 104 is connected so that the controller 120 can control the delivery of electrical energy to the controller 120, such as by switching on the supply of a pulse of electrical power.

A voltage profile may be provided in the drift region 103 using a series of drift electrodes 103a, 103b spaced apart along the drift region. Although not illustrated in FIG. 1, a repeller plate or other electrode may be arranged for extending this voltage profile into the reaction region 102. Between the reaction region 102 and the detector 118 the profile voltage varies spatially (e.g. as a function of displacement along the cell in the drift direction) to provide an electric field that moves ions along the cell 100 towards the detector 118. The electric field may be uniform and/or known along the drift region 103 and/or the reaction region 102.

The controller 120 includes a programmable processor, an output interface such as a DAC (not shown in the drawings) which is able to control the provision of appropriate electrical control signals and/or power supply to the ion shutter and to the ionisation source 104. The controller 120 is thus operable to operate the pulsed ionisation source 104, and to control the ion shutter. Typically, in operation the controller operates the pressure pulser to provide a sample of material into the reaction region. It then provides a sequence of cycles of operation. During each cycle the ioniser may be operated to ionise the sample. In each cycle of operation the gate is opened to allow the ions to travel towards the collector to provide detection signals at the collector electrode.

The controller 120 may store pre-configured gate width values and corresponding detection criteria associated with those gate widths. For example, the controller is configured so that detection signals for one gate width are analysed differently from those associated with a second different gate width. A variety of different analyses are possible. As a first example, for a detection signal associated with a shorter gate width the detection thresholds in selected time windows may be relatively low. By contrast, for a second detection signal obtained using longer gate width the thresholds in those time windows may be higher and/or certain time windows may be ignored altogether. The controller is also configured to perform particular actions such as triggering alerts indicating the presence of particular chemical hazards based on the combined results of one or two or more such analyses.

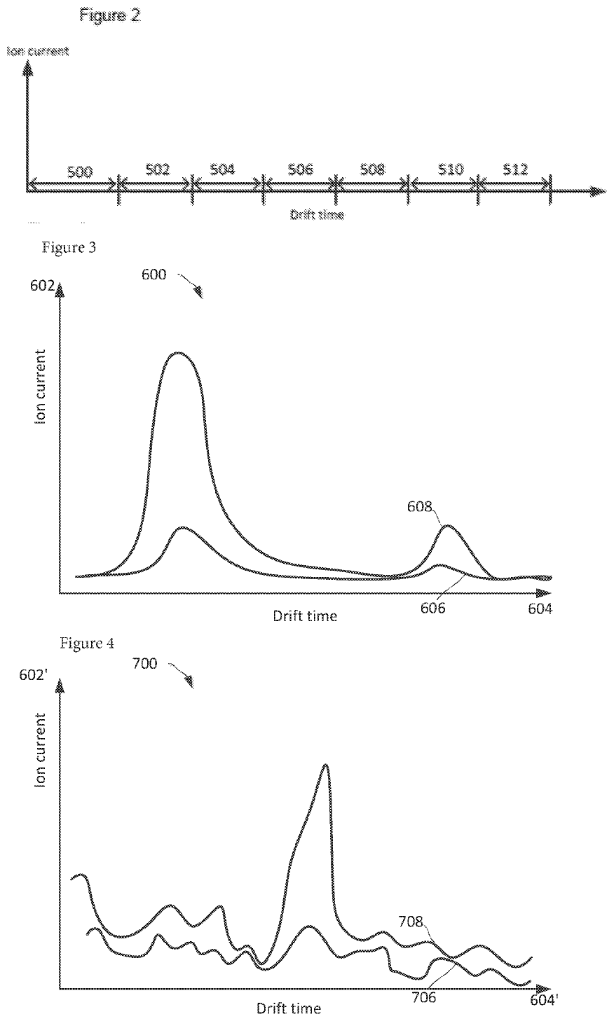

FIG. 2 is a schematic illustration of a set of time windows 500, 502, 504, 506, 508, 512. As illustrated each of these time windows corresponds to an interval of times of arrival (drift times) at the collector. Such time intervals typically are measured from operation (opening) of the gate. The detection signal during each time window may be based on the amplitude of ion current during that time window.

FIG. 3 illustrates two plots 606, 608 on a pair of axes. The x-axis 604 indicating drift time, and the y-axis indicating ion current measured at the detector. Both axes are unitless because the data are merely illustrative but the scaling applied to the two plots is equivalent to facilitate comparison. The first plot 606 indicates the ion current measured at the collector using a first gate width. The second plot 608 indicates the ion current measured at the collector for the same sample using a second gate width. The second gate width being longer than the first. It can be seen that in both of the two plots the monomer peak associated with a chemical in the sample is clearly detectable. The dimer peak however is relatively low in the short gate width data. For some chemicals, the monomer peak may coincide with interferent chemicals, so detection of the monomer peak alone may be insufficient to unambiguously identify the presence of such chemicals. Accordingly, detection of the dimer peak may be desired. To deal with such eventualities, the controller may be configured to switch to using the longer gate width in the event that, when using the shorter gate width a detection threshold is reached in the time window associated with the monomer peak. When analysing the detection signals collected using the longer gate width, the detection criteria used by the controller may include deactivating (e.g. ignoring) the time window associated with the monomer peak and/or window(s) associated with known interferents.

FIG. 4 illustrates two plots 706, 708 on a pair of axes 700. The x-axis 604′ indicates drift time, and the y-axis 602′ indicating ion current measured at the detector. Both axes are unitless because the data are merely illustrative but the scaling applied to the two plots is equivalent to facilitate comparison. The first plot 706 indicates the ion current measured at the collector using a first gate width. The second plot 708 indicates the ion current measured at the collector for the same sample using a second gate width. The second gate width being longer than the first. It can be seen that when using the first gate width, the monomer peak may not be reliably distinguishable from the background signal. Accordingly, the controller may be configured so that, in the event that a detection threshold is not met, the gate width is increases and a corresponding increase in the detection threshold is also provided in the relevant time windows.

It will be appreciated from the foregoing discussion that the controller is configured to selects the analysis to be used in each time window according to the gate width. It may be preconfigured in this way for the detection of particular chemical threats so that particular sequences of gate widths and corresponding detection criteria are preconfigured for the detection of particular chemicals. For example, in a first analysis, the controller may use a first set of detection thresholds in the time windows, the thresholds in particular time windows being selected based on the prevalence of particular known interferents and based on the signatures of the chemical hazard(s) to be detected.

The controller can then employ a sequence of gate widths and corresponding detection thresholds. These sequences can be provided in a variety of ways. This will now be explained with reference to two different embodiments of methods of operation of the spectrometer. In summary these two embodiments are:
Automatic switching between gate widths and detection logic settings.
Conditional switching of gate width and detection logic, for example switching of gate width and detection logic in the event that a particular chemical hazard is not detected using a default gate width.

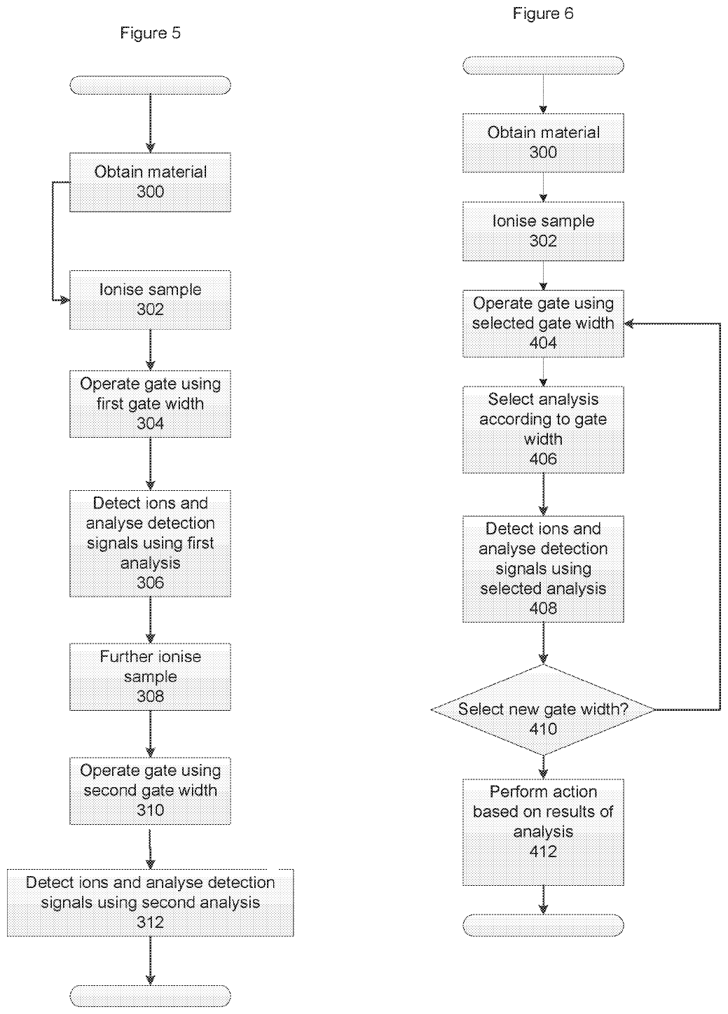

As illustrated in FIG. 5, in the first of these embodiments the controller is configured to switch between using a default gate width and using a first analysis in the respective time windows, and to switch automatically to a different gate width and a corresponding different analysis. The controller sets the gate width to an first value (such as a default gate width) and operates the pressure pulser to obtain 300 a sample of material in the reaction region and operates the ioniser to generate ions which ionise 302 the sample in the reaction region. The controller then operates 304 the gate using the first gate width, and selects a corresponding analysis based on the gate width. The controller then detects the arrival of ions at the collector electrode to generate detection signals, such as ion current associated with the arrival of ions at the collector. The controller analyses 306 the detection signals in a set of time windows according to the selected analysis. The controller then switches automatically to using a second different gate width and using a corresponding second analysis. For example it may further ionise 308 the sample in the reaction region and then operate 310 the gate using the second gate width before detecting the ions and analysing 312 the detection signals using a second analysis. The controller may be configured to determine whether a chemical hazard is present based on the results of the first analysis and/or the second analysis. For example, the two results may both be used together to determine whether a chemical hazard, e.g. to trigger an alarm.

The second analysis may be chosen according to the second gate width. The controller may be configured to switch from the first gate width to the second gate width after a selected number of cycles of operation at the first gate width or after a selected time interval. A certain degree of conditionality may be present in such a system. For example, in the event that a chemical hazard is detected in either of the two configurations, the controller may be configured to perform repeated cycles of operation in that configuration. This may be done until a predefined maximum amplitude threshold is reached. Once the threshold is reached, if the controller is in the second configuration it may revert to the original configuration (first gate width, first analysis) to avoid saturation of the instrument. Similarly, in the event no chemical hazard is detected using the default gate width the operation of the controller simply continues and switches automatically to using the second different gate width and the second analysis in the time windows. Then, if no hazard is detected the controller subsequently reverts automatically to the first configuration. It will be appreciated in the context of the present disclosure that more than two different configurations may be used in this sequence so that the controller switches automatically between three or more different gate widths and applies corresponding different analyses to the detection signals obtained at each different gate width.

FIG. 6 illustrates the second of the above embodiments. In this embodiment the detector switches between two or more settings of the ion gate opening time based on some predetermined condition. Initially, the controller sets the gate width to a first value (such as a default gate width) and operates the pressure pulser to obtain 300 a sample of material in the reaction region and operates the ioniser to generate ions which ionise 302 the sample in the reaction region. The controller then operates 404 the gate using the first gate width, and selects 406 a corresponding analysis based on the gate width. The controller then detects the arrival of ions at the collector electrode to generate detection signals, such as ion current associated with the arrival of ions at the collector. The controller analyses 408 the detection signals in a set of time windows according to the selected analysis.

The controller then determines 410 whether to select a new gate width and to perform further analysis. This may be done based on the results of the first analysis.

For example, in the event that a threshold is exceeded in a time window associated unambiguously with a chemical hazard, the controller may trigger an alert indicating the presence of that chemical hazard in which case no further gate width may be selected and the controller may perform 412 an action selected according to the time window in which the threshold has been exceeded.

On the other hand, in the event that the results of the first analysis are ambiguous in some way (e.g., a threshold being exceeded in a time window which may be associated with either a particular hazard or a known interferent but in which the two cannot be resolved) the controller selects 404 a second different gate width and selects 406 a second set of thresholds in the respective time windows. The second gate width and the second set of thresholds may be configured for detecting the particular chemical hazard and/or for suppressing detection of the interferent at the second gate width. In this eventuality, the controller then operates 404 the spectrometer, selects the corresponding analysis 406, operates the spectrometer to detect ions and analyses the detection signals using the second analysis 408.

The results of the first analysis and the second analysis may then be used together to determine whether the particular chemical hazard is present.

The minimum detectable concentration of the different threats is strongly dependent on the chemistry of the substances of interest. It was experimentally demonstrated that some threat agents could be detected at a first set of thresholds when the gate width is set to its lowest value. Other threats may require a very long gate width at those same thresholds.

It will be appreciated in the context of the present disclosure that dynamic adjustment of the detection algorithm may include the activation and/or deactivation of the certain time windows for some of the threats of interest. For example, certain windows may be only used in certain configurations of the detector and not used in others. Typically, this is done based on the configuration of the detector (e.g., gate width).

As will be appreciated in the context of the above disclosure, the controller selects the detection windows and the amplitude thresholds in those time windows according to the gate width. In some embodiments, in addition to adapting the thresholds according to the gate width, the detection logic may also be adapted according to the gate width. For example, the controller may be configured to trigger an alert at a particular gate width only if a threshold is exceeded in a time window associated with the presence of a monomer peak and/or in a time window associated a dimer peak of a particular chemical hazard. As another example, the detection logic for a particular gate width may include identifying presence of a particular peak shape in a particular time window.

In the second of the above embodiments, the controller is configured to perform a sequence of cycles of operation of the detector and to use a corresponding sequence of gate widths and detection analyses for these cycles of operation so that, in at least some cycles different gate widths and different analyses are used. For example, the controller is configured to operate the spectrometer to obtain a sample of material in the reaction region and then to operate the spectrometer to analyse this sample using a first gate width to obtain first detection signals. These first detection signals are then analysed using a corresponding analysis (e.g., detection logic such as thresholds, peak shapes, deactivated time windows etc.) selected for that gate width.

The ion gate opening time may initially be set to a default value and the controller may apply a default analysis to the resultant detection signals. However, if no alarms are generated, the opening time of the ion gate could be ramped up in steps to the longest opening times used for detection of threat at a selected threshold concentration (such as a hazardous concentration associated with one or more chemicals). If no alarms are generated, the detector may go back to the original (default) configuration after a few cycles. If an alarm is generated when the opening time of the ion gate will be set to an intermediate value. The detector will stay in that configuration until a maximum amplitude threshold defined into the detection algorithm will be reached and then the detector will revert to the original configuration to avoid saturation of the instrument. The detection windows, the amplitude thresholds and the logic defined in the algorithm will be correlated to the opening time of the ion gate.

As illustrated in FIG. 1 a drift gas may flow from the end of the drift region nearest the collector towards the gate. In these embodiments the time of arrival of the ions at the collector electrode depends on the mobility of the ions. In other embodiments the drift gas may be absent and the cell may be evacuated so as to provide a time of arrival at the collector electrode which is determined by mass to charge ratio. For example, the spectrometer may be a TOF mass spectrometer.

In some examples the functionality of the controller 120 may be provided by a general-purpose processor, which may be configured to perform a method according to any one of those described herein. In some examples the controller may include digital logic, such as field programmable gate arrays, FPGA, application specific integrated circuits, ASIC, a digital signal processor, DSP, or by any other appropriate hardware. In some examples, one or more memory elements can store data and/or program instructions used to implement the operations described herein. Embodiments of the disclosure provide tangible, non-transitory storage media including program instructions operable to program a processor to perform any one or more of the methods described and/or claimed herein and/or to provide data processing apparatus as described and/or claimed herein. The controller 120 may include an analogue control circuit which provides at least a part of this control functionality. An embodiment provides an analogue control circuit configured to perform any one or more of the methods described herein.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the disclosure, which is defined in the accompanying claims.

1. A spectrometer for detecting a substance of interest, the spectrometer comprising:
a chamber through which a number of sample ions travel from an ion gate to a collector electrode;
a detector, connected to the collector electrode for detecting arrival of sample ions at the collector electrode; and
a controller configured to:
control parameters of the spectrometer to selectively increase or decrease the number of sample ions which pass into the chamber upon each opening of the ion gate,
detect arrival of the sample ions at the collector electrode to obtain detection signals during a set of time windows following opening of the ion gate, and
analyse the detection signals in the time windows according to the parameters of the spectrometer to detect the presence of the substance of interest.

2. The spectrometer of claim 1 wherein the parameters comprise at least one of:
(i) gate width,
(ii) quantity of sample vapour introduced to a reaction region comprising an ioniser, and
(iii) a duration for which ions are kept in the reaction region before opening of the ion gate.

3. The spectrometer of claim 1 wherein analysing the detection signals according to the parameters comprises:
selecting at least one detection criterion based on the parameters, and
identifying the presence of the substance of interest based on the detection signals and the at least one detection criterion.

4. The spectrometer of claim 3 wherein the at least one detection criterion comprises a detection threshold in at least one of the time windows, wherein the at least one detection criterion comprises a signature associated with a substance of interest, and wherein the signature comprises an expected peak shape.

5. (canceled)

6. (canceled)

7. The spectrometer of claim 4 5 wherein the signature comprises a presence of a monomer peak and/or a dimer peak associated with the substance of interest.

8. The spectrometer of claim 1 wherein the controller is configured to select the time windows according to the parameters.

9. The spectrometer of claim 1 wherein the controller is configured to:
operate the spectrometer with first parameters to obtain first detection signals and to apply first detection criteria to the first detection signals, and then to
operate the spectrometer with second parameters to obtain second detection signals and to apply second detection criteria to the second detection signals, wherein the second detection criteria are different from the first detection criteria.

10. The spectrometer of claim 9 wherein the first detection criteria comprise first detection thresholds for the time windows.

11. The spectrometer of claim 9 wherein the second detection criteria comprise second detection thresholds for the time windows.

12. The spectrometer of claim 9, wherein the first detection criteria comprise, for at least one of the time windows, a signature associated with a substance of interest, and wherein the signature comprises at least one of (a) an expected peak shape; and (b) a presence of a monomer peak or a dimer peak or both a monomer peak and a dimer peak.

13. The spectrometer of claim 9 wherein the second detection criteria comprise, for at least one of the time windows, a signature associated with a substance of interest.

14. (canceled)

15. The spectrometer of claim 9 wherein the first parameters are different from the second parameters.

16. A method of controlling a spectrometer, the spectrometer comprising:
a chamber through which sample ions travel from an ion gate to a collector electrode wherein the spectrometer is configured to discriminate between ions based on their travel time to the collector electrode; and
a detector, connected to the collector electrode for detecting arrival of sample ions at the collector electrode;
the method comprising:
operating the spectrometer according to first parameters, and detecting arrival of the sample ions at the collector electrode to obtain first detection signals associated with the first parameters, and
operating the spectrometer according to second parameters, and detecting arrival of the sample ions at the collector electrode to obtain second detection signals associated with the second parameters wherein the first parameters are different from the second parameters
wherein said detection signals comprise detection of the arrival of ions during a set of time windows following opening of the ion gate,
the method further comprising analysing the first detection signals according to first detection criteria, and analysing the second detection signals according to second detection criteria, wherein the first detection criteria are different from the second detection criteria.

17. The method of claim 16 wherein the parameters comprise at least one of (i) gate width, (ii) quantity of sample vapour introduced to a reaction region comprising an ioniser, and (iii) a duration for which ions are kept in the reaction region before opening of the ion gate.

18. The method of claim 16 wherein the first detection criteria comprise first detection thresholds for the time windows.

19. The method of claim 16 wherein the second detection criteria comprise second detection thresholds for the time windows.

20. The method of claim 18 wherein the first detection criteria comprise, for at least one of the time windows, a signature associated with a substance of interest.

21. The method of claim 18 wherein the second detection criteria comprise, for at least one of the time windows, a signature associated with a substance of interest.

22. The method of claim 20 wherein the signature comprises an expected peak shape.

23. The method of claim 20 wherein the signature comprises a presence of at least one of a monomer peak and a dimer peak.

24. (canceled)

25. (canceled)
